(19) United States
(12) Patent Application Publication
(10) Pub. No.: US 2004/0137195 A1
(43) Pub. Date: Jul. 15, 2004

(54) Ventilated mat system

(76) Inventor: William A. Stephens JR., Houston, TX (US)

Correspondence Address: William P. Glenn, Jr., 2102 Mechanic Street, Suite 205, Galveston, TX, 77550, US

(21) Appl. No.: 10/340,476

(22) Filed: Jan. 10, 2003

(51) Int. Cl. B32B 3/10

(52) U.S. Cl. 428/119; 428/131

(57) ABSTRACT

A floor mat system for ventilating moisture having at least one sheet of protective material with a plurality of vents disposed between an upper and lower surface with a cross section and dispersal pattern to promote, simultaneously, the escape of vapor from beneath the mat system and the movement of traffic across the mat without causing a loss of structural integrity. In other embodiments, a ventilated mat system includes a barrier system below an upper surface of the mat to allow the escape of moisture but deter the passage of liquids to an adjacent flooring. Such a barrier system can take the form of a plug, sheet, insert or be integral to a ventilated mat system.

### TECHNICAL FIELD

The present invention relates generally to plastic or rubber floor mats providing a ventilated protective surface for use in locations with moist, damp and/or wet floors. More specifically the present invention relates to a ventilated mat system which enables moisture to escape from the flooring underneath the mat by a series of passages.

### BACKGROUND ART

In general, protective floor mats are designed and manufactured to protect the underlying flooring from pedestrian and other types of traffic. Unfortunately, such mats trap moisture and/or liquids beneath the mat which promotes mildew and mold growth in/on the flooring. Such moisture and growth can damage the underlying flooring.

Existing, perforated or rubber floor mats focus upon the removal of water/liquids from the upper or working surface of floor mats to provide a safe traffic surface. Such perforated floor mats are referenced in U.S. Pat. No. 6,451,400 issued to Brock et al. in 2002 (hereinafter Brock '400); U.S. Pat. No. 6,405,495 issued to Kessler et al. in 2002 (hereinafter Kessler '495); U.S. Pat. No. 5,992,105 issued to Kessler et al. in 1999 (hereinafter Kessler '105); and U.S. Pat. No. 3,909,996 issued to Ettlinger, Jr. et al (hereinafter Ettlinger '996). However, each of these references do not provide an upper or working surface which promotes the movement of wheeled equipment. The Brock '400 reference discloses multiple sets of pins for scraping the underneath of footwear. The disclosed pin sets do not provide a working surface which promotes the movement of wheeled equipment. The Kessler '495 and Kessler '105 references disclose a thin flexible mat system to provide a safe dry walking surface by means of perpendicular upper and lower strips that define a series of channels and spaces to carry water away from the walking surface. Only the Ettlinger '996 reference discloses a plurality of drainage openings in the tread surface to allow liquids to be removed from the tread surface and also ventilate the area beneath the mat. However, none of the references above, including Ettlinger '996, provide a work surface with a pattern of openings, drains, and/or passageways capable of sustaining foot and rolling traffic and simultaneously allow the ventilation of the underlying flooring.

Like perforated floor mats, absorbent mats perform a similar function of promoting a dry working surface with the use of an absorbent material. Such absorbent mats are referenced in U.S. Pat. No. 5,962,350 issued to Krotine in 1999; U.S. Pat. No. 5,549,945 issued to Lind in 1996; U.S. Pat. No. 5,114,774 issued to Maxim, Jr. in 1992; and U.S. Pat. No. 4,644,592 issued to Small in 1987. Each provide a safe walking surface in damp areas by shunting water from the upper surface to a region below the floor mat. Yet, none of the references provide ventilation of the underlying floor.

In view of the above described deficiencies associated with floor mats, the present invention has been developed to alleviate these drawbacks and provide further benefits to the user. These enhancements and benefits are described in greater detail hereinbelow with respect to several alternative embodiments of the present invention.

### SUMMARY OF THE INVENTION

The present invention in its several disclosed embodiments alleviates the drawbacks described above with respect to conventional floor mats and incorporates several additionally beneficial features.

It is one object of the present invention to provide a floor mat system that promotes ventilation of the underlying floor.

Its is another object of the present invention to provide a ventilated floor mat system which deters the passage of liquids on the floor mat's upper surface to the underlying floor.

It is a further object of the present invention to provide a ventilated floor mat system which does not impede foot or rolling traffic across the floor mat's upper surface.

It is an additional object of the present invention to provide a ventilated floor mat system which does not crack, split and/or loose its structural integrity with the application of foot, sliding and/or rolling traffic.

It is yet another object of the present invention to provide a floor mat system having the benefits of ventilating the underlying floor without the disadvantage of introducing liquids to the underlying floor.

It is still a further object of the present invention to provide a floor mat system having the benefits of ventilating the underlying floor without the disadvantage of a perforated upper work surface impeding foot, sliding and/or rolling traffic.

It is still an additional object of the present invention to provide a floor mat system having the benefits of ventilating the underlying floor without the disadvantage of cracking, splitting and/or losing structural integrity with the application of foot, sliding and/or rolling traffic.

It is again another object of the present invention to modify existing floor mat systems to promote ventilation of the underlying floor.

It is still a further object of the present invention to modify existing floor mat systems to deter the passage of liquids on the floor mat's upper surface to the underlying floor.

It is a further object of the present invention to modify existing floor mat systems with perforations which do not impede foot or rolling traffic across the floor mat's upper surface.

It is an additional object of the present invention to modify existing floor mat systems with perforations which do not cause the floor mat to crack, split and/or loose its structural integrity with the application of foot, sliding and/or rolling traffic.

It is yet another object of the present invention to modify existing floor mat systems to have the benefits of ventilating the underlying floor without the disadvantage of introducing liquids to the underlying floor.

It is still a further object of the present invention to modify existing floor mat systems to have the benefits of ventilating the underlying floor without the disadvantage of a perforated upper work surface impeding foot, sliding and/or rolling traffic.

It is still an additional object of the present invention to modify existing floor mat systems to have the benefits of ventilating the underlying floor without the disadvantage of cracking, splitting and/or losing structural integrity with the application of foot, sliding and/or rolling traffic.

The beneficial effects described above apply generally to each of the exemplary devices and mechanisms disclosed herein of the ventilated floor mat system. The specific structures through which these benefits are delivered will be described in detail hereinbelow.

### BRIEF DESCRIPTION OF THE DRAWINGS

The invention will now be described in greater detail in the following way of example only and with reference to the attached drawings, in which:

FIG. 1 is a perspective view of a ventilated floor mat system.

FIG. 2 is a perspective view of a ventilated floor mat system with studs

FIG. 3 is a cross sectional view of a ventilated floor mat system with stud ridging and restriction inserts.

FIG. 3a is a cross sectional view of a ventilated floor mat system with stud inserts.

FIG. 3b is a perspective view of a stud insert for a ventilated floor mat system.

FIG. 3c is a perspective view of a stud insert with a chimney.

FIG. 4 is a perspective view of a ventilated floor mat system with stud inserts.

FIG. 5 is a perspective view of a ventilated floor mat system with a barrier system including a barrier sheet.

FIG. 6 is a cross sectional view of a ventilated floor mat system with a barrier system including a barrier sheet and a channel.

FIG. 7 is a perspective view of a ventilated floor mat system with a barrier system including a framing system.

FIG. 8 is a cross sectional view of a ventilated floor mat system with a barrier system including a framing system.

FIG. 9 is a perspective view of an alternative embodiment of a ventilated floor mat system with a barrier system including a framing system.

FIG. 10 is a perspective view of an alternative embodiment of a ventilated floor mat system with a barrier system including a barrier sheet.

FIG. 11 is a perspective view of another alternative embodiment of a ventilated floor mat system with a barrier system including a barrier sheet.

FIG. 12 is a perspective view of another alternative embodiment of a ventilated floor mat system with a barrier system including an alternative framing system.

FIG. 13 is a perspective view of another alternative embodiment of a ventilated floor mat system with a barrier cavity.

FIG. 14 is a perspective view of another alternative embodiment of a framing system for use with a barrier cavity formed in a ventilated floor mat system.

FIG. 15 is a perspective view of another alternative embodiment of a framing system for use with a barrier cavity formed in a ventilated floor mat system.

FIG. 16 is a perspective view of a frame system for use with a barrier cavity formed in a ventilated floor mat system depicting fixation of a barrier sheet.

FIG. 17 is a cross sectional perspective view of an alternative frame system for use with a barrier cavity formed in a ventilated floor mat system depicting fixation of a barrier sheet.

FIG. 18 is a perspective view of a barrier insert for use with a ventilated mat system.

FIG. 19 is a perspective cross sectional view of a ventilated mat system with a barrier system including a barrier insert.

FIG. 20 is a perspective view of an alternative embodiment of a barrier insert for use with a ventilated mat system.

FIG. 21 is a perspective cross sectional view of a ventilated mat system with a barrier system including an alternative embodiment of a barrier insert.

FIG. 22 is a perspective view of another alternative embodiment of a barrier insert for use with a ventilated mat system.

FIG. 23 is a perspective cross sectional view of a ventilated mat system with a barrier system including an alternative embodiment of a barrier insert.

FIG. 24 is a perspective view of another alternative embodiment of a barrier insert for use with a ventilated mat system.

FIG. 25 is a cross section view of a ventilated mat system with a barrier system including an alternative embodiment of a barrier insert.

FIG. 26 is a perspective view of another alternative embodiment of a barrier insert for use with a ventilated mat system.

FIG. 27 is a cross section view of a ventilated mat system with a barrier system including another alternative embodiment of a barrier insert.

FIG. 28 is a perspective view of another alternative embodiment of a barrier insert for use with a ventilated mat system.

FIG. 29 is a cross section view of a ventilated mat system with a barrier system including an alternative embodiment of a barrier insert.

FIG. 30 is a cross section view of a ventilated mat system with another alternative embodiment of a barrier system.

FIG. 31 is a perspective view of a multi-tined bit.

### DETAILED DESCRIPTION OF THE INVENTION

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

Furthermore, elements may be recited as being “coupled”; this terminology's use contemplates elements being connected together in such a way that there may be other components interstitially located between the specified elements, and that the elements so specified may be connected in fixed or movable relation one to the other. Certain components may be described as being “adjacent” to one another. In these instances, it is expected that a relationship so characterized shall be interpreted to mean that the components are located proximate to one another, but not necessarily in contact with each other. Normally there will be an absence of other components positioned therebetween, but this is not a requirement. Still further, some structural relationships or orientations may be designated with the word “substantially”. In those cases, it is meant that the relationship or orientation is as described, with allowances for variations that do not effect the cooperation of the so described component or components.

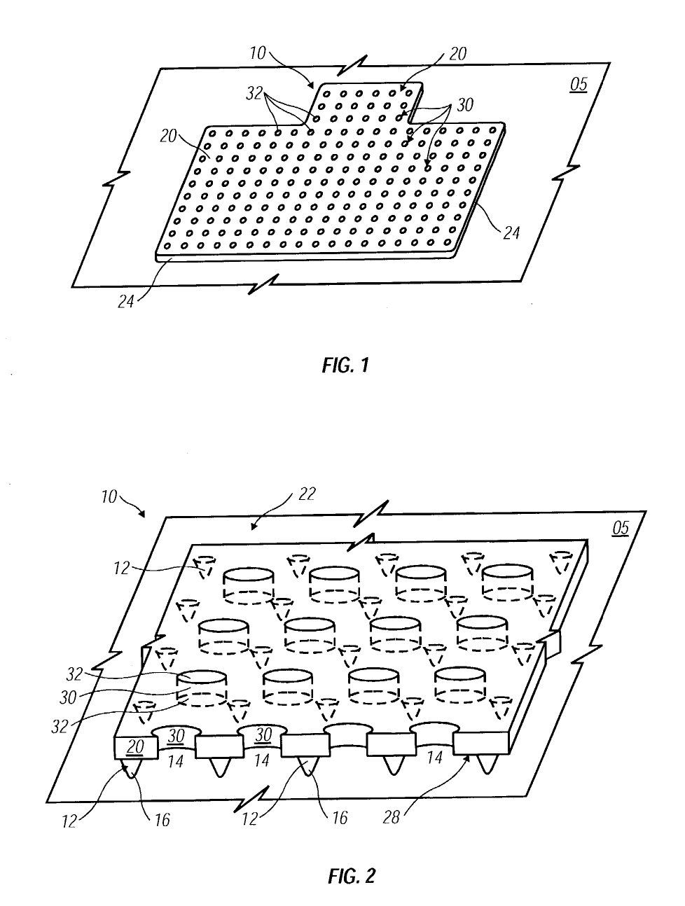

Referring to FIG. 1, a ventilated mat system 10 in its most basic form includes a sheet of protective material 20 with an upper, side and lower surfaces 22, 24, 28. A protective sheet 20 can be stiff or resilient material in the form of sheets typically used to create chair, door and/or work mats. Examples of such material, include but are not limited to vinyl, co-polymer, parquet flooring material, acrylic, rubber, and/or polycarbonate resin sheet material (like. LEXAN®). It is further contemplated that a protective sheet 20 may be a laminate of materials (similar or different) to provide an anti-fatigue traffic surface and/or increase structural integrity. Upper and lower surfaces 22, 28 may have a smooth, textured, brushed, rough, dimpled, ribbed and/or patterned finished (not shown). A finish of an upper surface 22 and a lower surface 28 may be different from each other. The thickness of a protective material 20 ranges between about 0.1″ to 0.5″.

Referring to FIG. 1, a ventilated mat system 10 includes a plurality of passages or vents 30 disposed between an upper and a lower surface 22, 28 of a protective sheet 20. Openings 32 of each end of vents 30 are located in an upper and a lower surfaces 22, 28. Each opening 32 and vent 30 has a cross section and dispersal pattern about a protective sheet 20 to promote the escape of moisture from flooring 05 beneath a protective sheet 20. It is contemplated that an underlying flooring 05 includes but is not limited to wood, carpet, tile, vinyl, cement, stone, steel, composite materials and/or fiberglass.

The cross section and dispersal pattern of openings 32 and/or vents 30 are such that a sheet 20 does not crack, split and/or lose structural integrity with initial or repeated traffic (including but not limited to walking, sliding and/or rolling) about an upper surface 22. As can be appreciated the cross sectional shape and size of openings 32 and/or vents 30 can be circular, arcuate, square, rectangular, triangular, polygonal and/or other shapes (including but not limited to symbols, letter or a combination thereof). Similarly, the dispersal pattern of openings 32 and/or vents 30 can be random, pre-determined and/or recurring patterns (including but not limited to circular, arcuate, square, rectangular, triangular, polygonal, symbolic, letter(s), words, figures, logos, pictures, or a combination thereof). The cross section of openings 32 and/or vents 30 can be uniform or vary for each individual opening 32 and/or vent 30.

Testing demonstrates that the structural integrity of a ventilated mat system 10 is compromised if circular openings 32 exceed a diameter of about 0.25″ in a rectilinear dispersal pattern on less than about 1″ centers. Furthermore, circular openings 32 having a diameter greater than about 0.25″ hamper the ability of traffic to roll or slide across a ventilated mat system 10. In one embodiment, a ventilated mat system 10 includes a protective sheet 20 made of vinyl about 0.125″ thick having about 0.125″ diameter circular cross-section openings 32 and vents 30 dispersed in a rectilinear pattern on about 2″ centers to allow traffic to proceed without cracking, splitting and/or losing the structural integrity of a ventilated mat system 10.

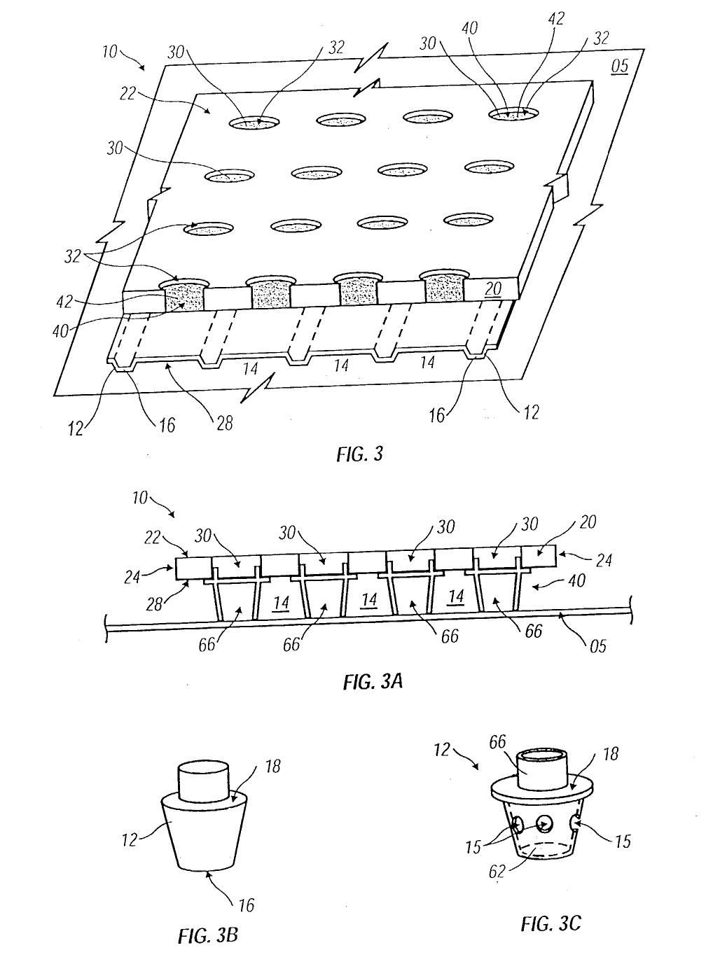

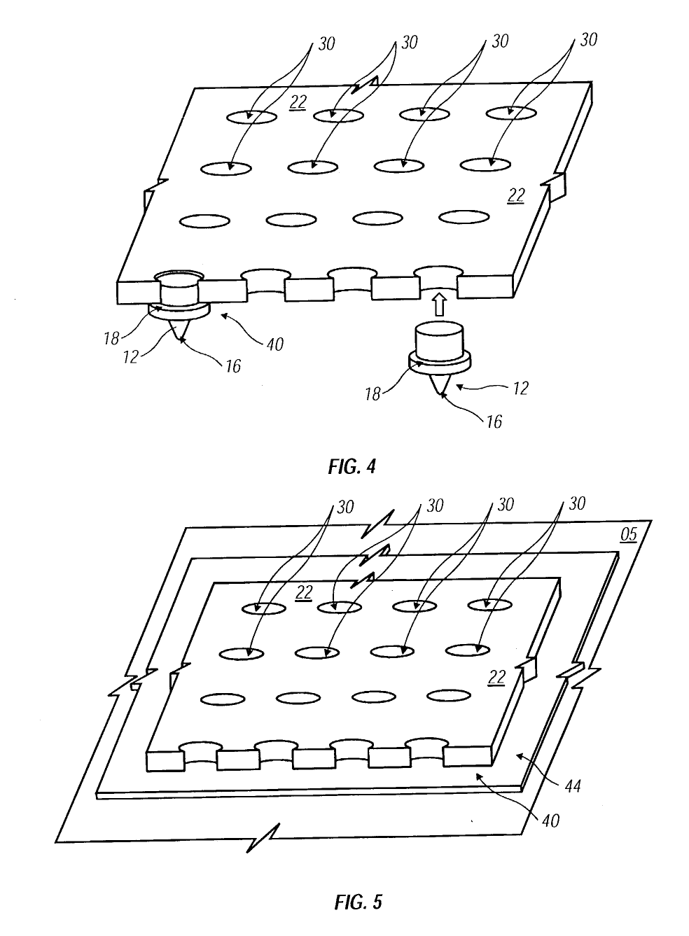

Referring to FIGS. 2 through 4, a ventilated mat system 10 includes studs or stud ridges 12 projecting away from lower surface 28; and when in contact with a flooring 05, at least one gap 14 is formed between a lower surface 28 and a flooring 05. When a flooring 05 is carpeting or other pliable floor coverings, the volume of a gap 14 is reduced and studs 12 further act to secure a ventilated mat system 10 to a flooring 05. In another embodiment, openings 32 are located in a lower surface 28 between studs 12 to encourage ventilation of a gap 14 (See FIGS. 2 and 3). In one embodiment, as shown in FIG. 3A, 3B and 3C, studs 12 are removeable inserts configured to be removably inserted into a number of vents 30 and extend beyond openings 32 located in a lower surface 28. Furthermore, studs 12 are configured to be removably inserted through selected openings 32 in a lower surface 28 and into corresponding vents 30 no further than a stud shoulder 18 (See FIG. 4). It is further contemplated, although not shown, that a stud shoulder 18 is not required if a stud 12 is configured to fit tightly within a vent 30.

As shown in FIGS. 2 through 4, a distal region 16 of a stud or stud ridge 12 may be pointed, rounded, flat, flared or a combination thereof. It is further contemplated that a distal region 16 includes a footing or base which is wider than a stud 16 (not shown). The cross section and dispersal pattern of studs or stud ridges 12 work in conjunction with the cross section and dispersal pattern of openings 32 and/or vents 30 to eliminate or at least reduce cracking, splitting and/or loss of structural integrity to a ventilated mat system as traffic loads are applied. As can be appreciated the cross sectional shape and size of studs or stud ridges 12 can be circular, arcuate, square, rectangular, triangular, polygonal and/or other shapes (including but not limited to symbols, letter or a combination thereof). Similarly, the dispersal pattern of studs or stud ridges 12 can be random, pre-determined and/or recurring patterns (including but not limited to circular, arcuate, square, rectangular, triangular, polygonal, symbolic, letter(s) words or a combination thereof). Furthermore, the cross section of studs or stud ridges 14 can be uniform or vary for each individual stud or stud ridge 12.

As depicted in FIGS. 3A, 3B, 3C and 4, a stud 12 may be solid (See FIGS. 3B and FIG. 4), have a chimney 66 (See FIG. 3A) or have a chimney 66 fluidly connected to a portal 15 and a reservoir 62 located at a distal region 16 of a stud 12 (See FIG. 3c). As shown in FIG. 3C, a reservoir 62 is formed in a stud 12 below a portal 15. A reservoir 62 formed in a stud 12 keeps liquids that have entered a vent 30 from being introduced to adjacent flooring 05.

Referring to FIGS. 3, 5, 7, 9, 10, 11, 12, 13, 14, and 15, a ventilated mat system includes a barrier system 40 positioned below an upper surface 22 to prevent or at least discourage liquid(s) from passing through vents 30 to a flooring 05. As discussed below, a barrier system 40 includes a barrier plug 44 or a barrier sheet 44 configured to at least operate as an effective barrier to liquids passing through vents 30.

In one embodiment, as shown in FIG. 3, a barrier system 40 includes at least one barrier plug or wad 42 of hydrophillic material positioned into a significant number of vents 30 to absorb liquid(s) which enter vents 30. A barrier plug or wad 42 is comprised of cotton, sponge, or any combination thereof. A barrier plug or wad 42 can be inserted through openings 32 located on upper surface 22 and/or lower surface 28.

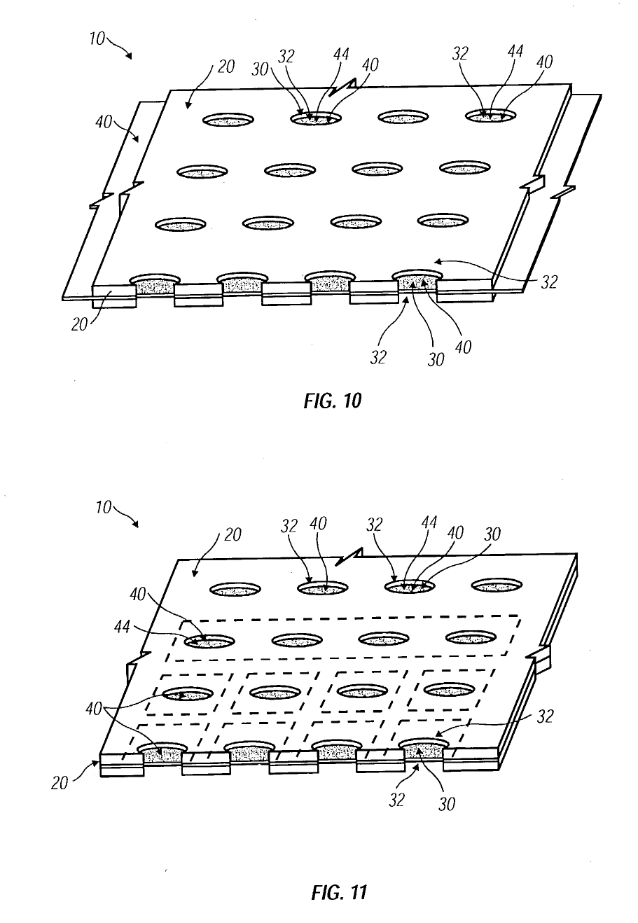

FIGS. 5, 7, 9, 10, 11, 12, 13, 14, and 15 illustrate alternative embodiments of a ventilated mat system 10 in which at least one barrier system 40 in the form of at least one barrier sheet 44, is fixed below an upper surface 22. More specifically FIGS. 5 through 9 illustrate embodiments of a ventilated mat system 10 in which at least one barrier sheet 44 is fixed to cover a significant number of openings 32 located on a lower surface 28. FIGS. 10 through 17 illustrate alternative embodiments of a ventilated mat system 10 in which at least one barrier sheet 44 is fixed between upper surface 22 and lower surface 28. A barrier sheet 44 may be manufactured out of materials which include expanded polytetrafluoroethylene, expanded polystyrene and/or other materials which function as an effective barrier to liquids yet allow vapor to pass through.

FIGS. 5 through 9 illustrate embodiments of a ventilated mat system 10 in which at least one barrier sheet 44 is fixed to cover a significant number of openings 32 located in lower surface 28. A barrier sheet 44 may take the form of one continuous sheet which spans at least a significant area of lower surface 28 and covers openings 32 located in a lower surface 28 (See FIG. 5). Alternatively, barrier sheet 44 may take the form of a plurality of patches and/or strips covering openings 32 located in lower surface 28 (not shown). Fixation of a barrier sheet 44 to cover openings 32 in a lower surface 28 may be accomplished through the use of adhesives (permanent or re-useable), heat-sealing, radio-frequency, and/or ultrasonic welding between a barrier sheet 44 and an upper surface 22, a side surface 24 and/or a lower surface 28.

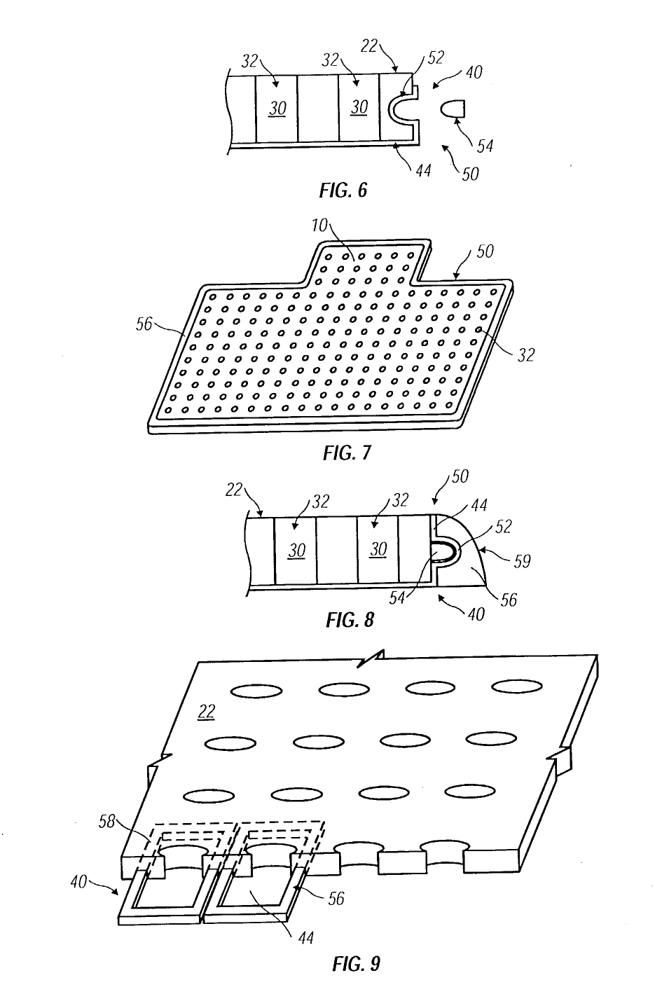

Removable fixation of a barrier sheet 44 to cover openings 32 in a lower surface 28 may be accomplished through the use of adhesives and/or self gripping fasteners (not shown). An alternative removable fixation embodiment includes a framing system 50 (See FIGS. 6 through 9). In a preferred embodiment of removably fixation of a barrier sheet 44, a barrier system 40, includes a framing system 50 to hold a barrier sheet 44 at a periphery region 46. In one embodiment, a framing system 50 includes a channel 52 formed in a protective sheet 20 to receive and hold in place a portion of a periphery region 46 by a spline 54 (See FIG. 6). At least one channel 52 is formed in an upper surface 22, a side surface 24 and/or a lower surface 28.

As an alternative embodiment, framing system 50 includes a removable frame 44 on to which a barrier sheet 44 is fixed (See FIGS. 7 and 9). Permanent fixation a barrier sheet 44 to a frame 56 can be accomplished through the use of adhesives, heat-sealing, radio-frequency and/or ultrasonic welding. Removable fixation can be accomplished through the use of re-useable adhesives (not shown), self gripping fasteners (not shown), and/or a channel 52 and a spline 54 (See FIGS. 7 through 9). Tensioning a barrier sheet 44 can be performed by fixing different portions of a periphery region 46 into a channel 52 with a spline 54 (See FIG. 8).

FIG. 7 illustrates a preferred embodiment of a ventilated mat system 10 which positions a protective sheet 20 inside a framing system 50 such that a barrier sheet 44 covers openings 32 in a lower surface 28 to at least discourage the passage of liquid to an underlying flooring 05. FIG. 8 depicts yet another embodiment of a framing system 50 which includes a beveled or chamfer outer perimeter 59 of a frame 56 to encourage a smooth transition for traffic between a flooring 05 and a ventilated mat system 10. An alternative embodiment of a ventilated mat system 10 includes a frame channel 58 in a protective sheet 20 to receive a frame 56. A frame channel 58 may be formed in a side surface 24 and/or a lower surface 28 (See FIG. 9).

FIGS. 10 through 15 illustrate another embodiment of a ventilated mat system 10 in which at least one barrier system 40 includes a barrier sheet 44 fixed between an upper surface 22 and a lower surface 28 in the form of: a continuous sheet spanning through at least a significant number of vents 30 (See FIG. 10); and/or a plurality of patches and/or strips spanning through least a significant number of vents 30 (See FIG. 11).

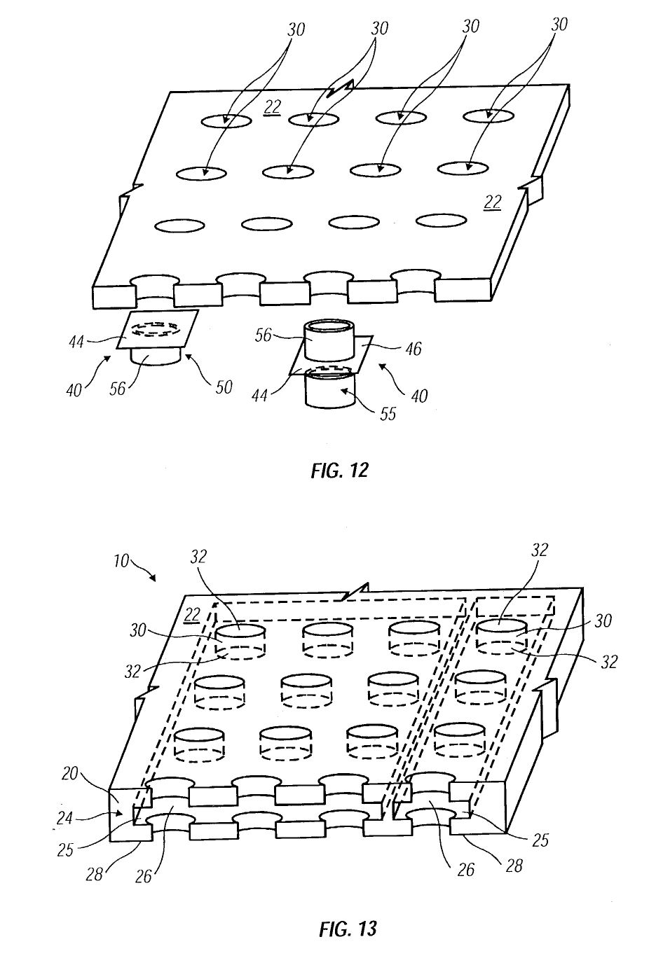

In a preferred embodiment of a barrier system 40, permanent fixation of a barrier sheet 44 between upper surface 22 and lower surface 28 and across vents 30 is done so through a lamination process which includes the use of adhesives, heat-sealing, radio-frequency, ultrasonic welding and/or a removable framing system 50 as described below (See FIGS. 12 through 17).

FIG. 12 (on the left had side) shows an embodiment of a removable framing system 50 which includes a removable frame 56 configured to fit and hold a barrier sheet 44 at a periphery region 46 inside a vent 30. FIG. 12 (on the right hand side) shows an alternative preferred embodiment of a framing system 50 which includes a removable frame 56 and an inner frame 55 between which a periphery region 46 of a barrier sheet 44 is fixed not unlike a swatch of fabric to an embroidery hoop. More specifically, an inner frame 55 is configured to fit and hold a barrier sheet 44 inside a removable frame 56.

In either embodiment depicted in FIG. 12, a removable frame 56 is configured to fit into a vent 30 through openings 32. Likewise, in either embodiment, a removable frame 56 and/or an inner frame 55 is configured to extend through an opening 32 and slightly beyond an upper surface 22 to promote traffic traction and at least discourage liquids from traveling along an upper surface 22 into vents 30 (not shown). Furthermore, in either embodiment, a removable frame 56 and/or an inner frame 55 is configured to extend through an opening 32 and beyond a lower surface 28 to create a stud 12 which creates at least one gap 14 between a lower surface 28 and a flooring 05 and further act to secure a ventilated mat system 10 (not shown).

FIGS. 13 through 17 show alternative embodiments of removable framing system 50 which includes at least one barrier cavity 26 formed in a protective sheet 20. A barrier cavity 26 and a framing system 50 are configured to cooperatively position and seat at least one barrier sheet 44 across at least one vent 30 to discourage the passage of liquid yet allow vapor to pass. Seating of a barrier sheet 44 across at least one vent 30 may occur by contacting a barrier sheet 44 directly to a surface of a barrier cavity 26 and/or by contacting frame 56 and/or frame support members 51 directly to a surface of a barrier cavity 26.

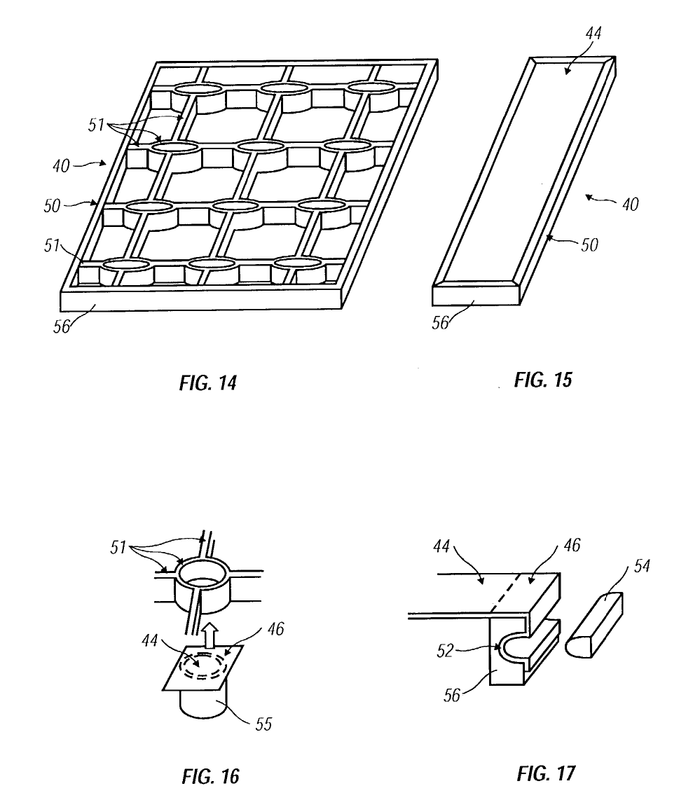

FIGS. 13 through 17 illustrate an alternative embodiment of a framing system 50 in which at least one barrier sheet 44 is fixed to at least one removable frame 56 at a periphery region 46. In addition to being configured to work cooperatively with a barrier cavity 26, a frame 56 and/or a support member 51 is further configured to provide structural integrity of protective sheet 20 across a barrier cavity 26 (See FIGS. 14 through 16).

Permanent fixation at least one barrier sheet 44 to at least one frame 56 can be accomplished through the use of adhesives, heat-sealing, radio-frequency and/or ultrasonic welding. Removable fixation can be accomplished through the use of adhesives (not shown) and/or self gripping fasteners (not shown). Fixation (permanent or otherwise) of a barrier sheet 44 can be adjusted by fixing different portions of a periphery region 46 to a frame 56 (See FIG. 16). In another embodiment, a channel 52 is formed in a frame 56 to receive and hold in place a portion of a periphery region 46 by a spline 54 (See FIG. 17). Where a spline 54 is included in any of the embodiments of a ventilated mat system 10, it is contemplated to be rigid, semi-rigid and/or flexible.

In a preferred embodiment, at least one framing system 50 is introduced into at least one barrier cavity 26 through at least one side opening 25 located at a side surface 24. In another embodiment, at least one barrier cavity 26 is formed in protective sheet 20 by at least two opposing shells 29 which are releaseably coupled to one another between upper surface 22 and lower surface 28 (not shown). It is further contemplated that opposing shells 29 can be hinged or non-hinged.

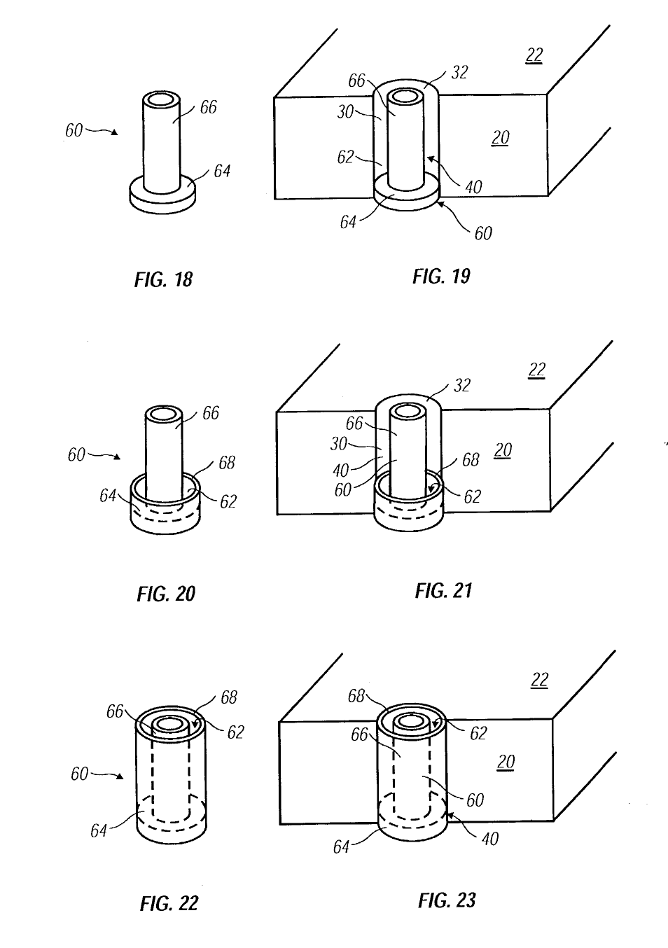

Referring to FIGS. 3C, 18 through 29, an alternative embodiment of barrier system 40 includes a restriction insert 60 when placed into a vent 30 forms a reservoir 62 below an upper surface 22. A restriction insert 60 can be formed out of plastic, metal, rubber and/or any material (or combination thereof) which can take the necessary form as described below to retain liquid in a reservoir 62 and further allow the passage of vapor through a tubule or chimney 66. As described above, a stud 12 with a chimney 66 is an embodiment of a restriction insert 60 in which a chimney 66 is fluidly connected to a portal and a reservoir 62 formed in a distal region 16 of a stud 12. In a preferred embodiment, a restriction insert 60 includes a plate 64 fixed to an outer periphery of at least one tubule or chimney 66 (See FIG. 18). A plate 64 is configured to fit (removably or permanently) into an opening 32 to form a reservoir 62 in the lower region of a vent 30 (See FIG. 19). Inner walls defining a vent 30 and outer walls of a chimney 66 form sides of a reservoir 62. A volume of a reservoir 62 can be easily varied by fixation of an end plate in a vent 30 and/or the length of a chimney 66.

A further embodiment of a restriction insert 60 includes a plate 64 and at least one wall 68 extending away and around a peripheral region of a plate 64 to form a reservoir 62 inside a wall 68 and an end plate 64 (See FIGS. 20 through 25). In yet another embodiment of a restriction insert 60, a wall 68 and an end plate 64 are configured to form at least one chimney 66 outside a restriction insert 60 when inserted into a vent 30 (See FIGS. 28 and 29). In any embodiment where a wall 68 is contemplated as part of restriction insert 60, a wall 68 may extend through an opening 32 and slightly above an upper surface 24 to form a ridge 65 to promote traction and/or discourage the flow of liquids into a vent 30 (See FIG. 29).

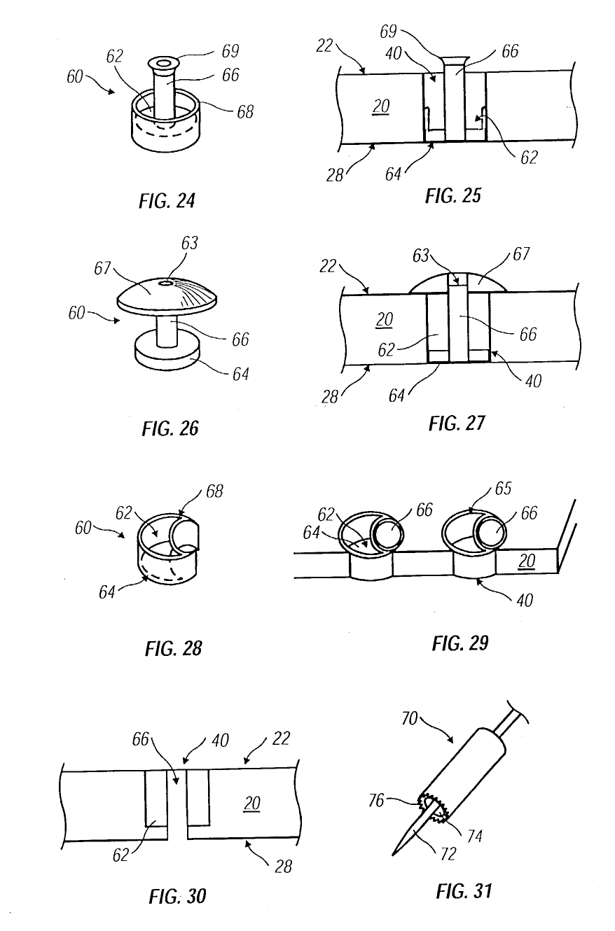

In yet another embodiment as shown in FIGS. 24 through 27, a chimney 66 can be flexibly stiff having a length slightly longer than a vent 30, such that when a restriction insert 60 is positioned, an end region 69 of a chimney 66, distal to a plate 64, extends slightly above upper surface 24 to promote traction and reduce slippage and/or skidding of traffic on upper surface 24. An end region 69 of a chimney 66 can be blunt, tufted, flared (See FIGS. 24 and 25), pointed, spherical or any other configuration which promotes traction and reduces slippage. In another embodiment as shown in FIGS. 26 and 27, an end region 69 is fitted with a cap 67 (removable or fixed) configured to occlude a significant portion of a vent 30 (See FIG. 27). A cap 67 includes at least one pore 63 coupled to a chimney 66 to allow the escape of vapor (See FIGS. 26 and 27).

Referring to FIG. 30, an alternative embodiment of a barrier system 40 includes a reservoir 62 and chimney 66 integral to sheet 20 and in vents 30. In one method of construction, a revolving bit 70 (See FIG. 31) is used to form a vent 30, a reservoir 62 and a chimney 66 in a sheet 20. A bit 70 includes a central cutting region 72, and at least one outer cutting region 76, of which central cutting region 72 is longer than outer cutting region 76. A gap 74 between central and outer cutting regions 72,76 define wall thickness of a chimney 66. The width of bit 70 defines the diameters of a passage 32, a vent 30 and a reservoir 62. In yet another embodiment, a bit 70 is a spade bit in which a central cutting region 72 includes at least one central tine and an outer cutting region includes at least two outer tines (not shown).

In a preferred method of manufacturing a ventilated mat system 10 or modifying an existing mat, at least one bit 70 mounted in a drilling device (hand, press or otherwise) cuts through upper surface 24 boring out a passage 32, a vent 30, a chimney 66 and a reservoir 62. A chimney 66 is not completely formed until central cutting region 72 pierces a lower surface 28. The depth of a reservoir 62 is determined by a cutting depth of outer cutting region 76.

A ventilated mat system and its components have been described herein. These and other variations, which will be appreciated by those skilled in the art, are within the intended scope of this invention as claimed below. As previously stated, detailed embodiments of the present invention are disclosed herein; however, it is to be understood that the disclosed embodiments are merely exemplary of the invention that may be embodied in various forms.

What is claimed and desired to be secured by Letters Patent is as follows:

1. A floor mat system for venting moisture, comprising:
at least one sheet of protective material forming a mat having a plurality of vents disposed between an open to an upper and a lower surface of said mat, said plurality of vents having a cross section and dispersal pattern in said mat to promote, simultaneously, the escape of vapor beneath said lower surface and the movement of traffic across said upper surface without causing said sheet to loose structural integrity.

2. The floor mat system as claimed in claim 1, wherein a plurality of studs project and extend away from said mat to form a gap between said lower surface and said flooring; and said vents are positioned in said mat between said studs to encourage ventilation of said gap.

3. The floor mat system as claimed in claim 2, wherein said studs comprise a chimney fluidly connected to a reservoir and at least one portal formed in said stud, said reservoir is positioned below said portal.

4. The floor mat system as claimed in claim 1, wherein a barrier system is coupled to said mat to at least discourage liquids from passing through said mat to said flooring, said barrier system comprising at least one barrier system configured to allow said escape of vapor and at least discourage liquids from passing through said vents.

5. The floor mat system as claimed in claim 4, wherein said barrier system is a hydrophillic material in the form of a barrier plug and said barrier plug is positioned in said vents.

6. The floor mat system as claimed in claim 4, wherein said barrier system is a breathable membrane fabric in the form of a barrier sheet with a peripheral region, said peripheral region is coupled to said mat to position a portion of said barrier sheet adjacent to said lower surface and cover said vents.

7. The floor mat system as claimed in claim 4, wherein said barrier system is a breathable membrane fabric in the form of a barrier material sheet with a peripheral region, said peripheral region is coupled to said mat to pass a portion of said barrier sheet through said vents between said upper and lower surfaces.

8. The floor mat system as claimed in claim 4, wherein said barrier system is a solid material in the form of a restriction insert, said restriction insert comprising an end plate positioned adjacent to a chimney and positioned in said vent to form a reservoir above said end plate and adjacent to a portion of said chimney; and wherein said chimney is configured to allow said escape of vapor and said reservoir is configured to at least discourage liquids from passing through said vents.

9. The floor mat system as claimed in claim 8, wherein said chimney passes through said end plate.

10. The floor mat system as claimed in claim 9, wherein said chimney is flexibly stiff and comprises a first and second end region, said first end region passes through said end plate, and said second end region extends slightly above said upper surface to promote traction and reduce slippage or skidding of traffic when said restriction insert is positioned in a said vent.

11. The floor mat system as claimed in claim 10, wherein a cap is fixed to said second end region to occlude a significant portion of said vent 30, said cap having at least one pore coupled to said chimney to allow said escape of vapor.

12. The floor mat system as claimed in claim 9, wherein said at least one restriction insert further comprises at least one wall extending away and around a peripheral region of said end plate to form said reservoir in said restriction insert.

13. The floor mat system as claimed in claim 8, wherein said at least one restriction insert further comprises at least one wall extending away and around a peripheral region of said end plate, said at least one wall and said at least one end plate configured to form a said reservoir in said restriction insert and a chimney outside said restriction insert when inserted into at least one said vent.

14. The floor mat system as claimed in claim 1, wherein at least one reservoir and at least one chimney are formed integral to said protective sheet and in said at least one vent.

15. A method of producing a ventilated floor mat, comprising the steps of
cutting with a multi-tined revolving bit through an upper surface of a sheet of protective material to bore out a vent and reservoir in said sheet of protective material and a chimney through said sheet of protective material, wherein said bit comprises a central cutting tine and outer cutting tines configured to define the shape of said vent, chimney and reservoir; and
repeating said cutting step at different locations on said upper surface wherein said vent locations promote, simultaneously, venting of moisture beneath the floor mat and movement of traffic across said upper surface without causing the floor mat to crack, split or loose structural integrity.
